(19) United States
(12) Patent Application Publication
(10) Pub. No.: US 2026/0291669 A1
(43) Pub. Date: Sep. 24, 2026

(54) SIDELINK WIRELESS COMMUNICATION METHOD AND APPARATUS

(71) Applicant: Apogee 5G Global, LLC, Plano, TX (US)

(72) Inventors: Jinfang ZHANG, Shanghai (CN); Xiaobo ZHANG, Shanghai (CN)

(73) Assignee: Apogee 5G Global, LLC, Plano, TX (US)

(21) Appl. No.: 19/136,632

(22) PCT Filed: Nov. 13, 2023
(86) PCT No.: PCT/CN2023/131167

§ 371 Date: Jun. 10, 2026

(30) Foreign Application Priority Data
Dec. 6, 2022 (CN) 202211554223.3

(51) Int. Cl. H04L 5/00; H04L 1/1867

(52) U.S. Cl. CPC H04L 5/0044; H04L 1/1896; H04L 5/0005

(57) ABSTRACT

The present application discloses a sidelink wireless communication method and apparatus. A user equipment (UE) receives a first message indicating a first period value and a periodic time-frequency resource set. The UE sends a first physical uplink shared channel (PUSCH) group during a first period. A time-frequency resource set occupied by the first PUSCH group belongs to the periodic time-frequency resource set. The first PUSCH group comprises a second message, and the second message indicates a cache state. The UE monitors a target signaling after a reference time and before a first physical downlink control channel (PDCCH) has been received. The first PDCCH is used for scheduling a new transmission. The first PUSCH group comprises one or more PUSCHs. The duration of the first period is the first period value. The reference time is related to the first PUSCH group.

### TECHNICAL FIELD

The present application relates to a method and apparatus in a wireless communication system, and in particular to, a method and apparatus for supporting XR service transmission in wireless communication.

### BACKGROUND ART

In response to the rapid development of XR (extended Reality) usage scenarios and services, 3GPP (3rd Generation Partner Project) RAN1 (Radio Access Network 1) launched an SI (Study Item) in Release 17 for “Study on XR Evaluations for NR”. The study believes that XR is an important usage scenario and service for Release 18 and subsequent releases. XR refers to various types of augmented, virtual and mixed environments, which perform human-machine communication with the help of handheld and wearable end-user equipment (UE). Many XR use cases have quasi-periodic and high-data-rate service characteristics, and stricter packet delay budgets (PDBs), which bring a series of challenges to NR (New Radio).

### SUMMARY OF THE INVENTION

The inventors found through research that a configured grant (CG) pre-configures periodic transmission resources, which is suitable for periodic services and can effectively reduce scheduling signaling overhead. However, due to the quasi-periodicity of XR services on one hand and the unpredictable data packet size of XR services on the other hand, when the periodically allocated transmission resources are insufficient for transmission, the remaining data packets need to be transmitted through dynamic scheduling. How to support the transmission through the combination of the configured grant and the dynamic scheduling is a key problem that needs to be solved in XR services.

In response to the above problem, the present application discloses a solution, in which the UE indicates the data to be transmitted to the network by a configured uplink grant. The UE monitors a dynamic scheduling signaling in the following period of time until a new transmission scheduling for the UE is received. The present application can effectively support services with quasi-periodicity or unpredictable data packet sizes, reduce transmission delays, and improve user experience. In the description of the present application, the XR scenario is only used as a typical application scenario or example; the present application is also applicable to scenarios other than XR which are facing similar problems, such as eMBB (Enhance Mobile Broadband), URLLC (Ultra Reliable and Low Latency Communication), MBS (Multicast and Broadcast Services), IoT (Internet of Things), Internet of Vehicles, NTN (non-terrestrial networks), shared spectrum, and VolP, and achieves technical effects similar to those in the XR scenario. In addition, the use of a unified solution for different scenarios (including, but not limited to, XR, eMBB, URLLC, MBS, IoT, Internet of Vehicles, NTN, shared spectrum, and VolP) can also help to reduce hardware complexity and cost, or improve network performance. In an absence of conflict, embodiments and features in the embodiments in a first node of the present application can be applied to any other node, and vice versa. In the case of no conflict, the embodiments and features in the embodiments of the present application may be arbitrarily combined with each other. In particular, the interpretation of the terminologies, nouns, functions, and variables in the present application (if not specifically noted) can refer to the definitions in the specification protocols TS36 series, TS38 series, and TS37 series of 3GPP.

The present application discloses a method used in a first node for wireless communication, comprising:
receiving a first message, the first message indicating a first period value and a periodic time-frequency resource set;
sending a first PUSCH group during a first period, a time-frequency resource set occupied by the first PUSCH group belonging to the periodic time-frequency resource set, the first PUSCH group comprising a second message, and the second message indicating a cache state; and
monitoring a target signaling after a reference time and before a first PDCCH has been received, the first PDCCH being used for scheduling a new transmission,
wherein, the first PUSCH group comprises Q PUSCHs, Q being a positive integer greater than 0; the duration of the first period is the first period value; and the reference time is related to the first PUSCH group.

As one embodiment, the problems to be solved by the present application comprise: How to effectively support the transmission of quasi-periodic services or of services having unpredictable data packet sizes through configured grant transmission.

As one embodiment, the problems to be solved by the present application comprise: How to match the characteristics of XR services by enhancing the configured grant transmission to improve the transmission performance of the uplink.

As one embodiment, the above method may quickly give an indication to a base station by sending the second message through the first PUSCH (Physical Uplink Shared Channel) group.

As one embodiment, the second message is used for indicating data that has not yet been transmitted.

As one embodiment, the second message is used for triggering a dynamic scheduling.

As one embodiment, a time after a reference time and before a first PDCCH (Physical Downlink Control Channel) has been received is an active time.

As one embodiment, the above method may effectively support the transmission of the dynamic scheduling by monitoring the target signaling during the active time.

As one embodiment, the above method prevents the UE from entering the DRX (Discontinuous Reception) OFF state and missing a dynamic scheduling signaling.

As one embodiment, the above method avoids the inconsistent understanding of DRX between the communicating parties (the first node and a second node of the present application).

According to one aspect of the present application, the above method comprises: the reference time is a sending time of the PUSCH carrying the second message in the first PUSCH group.

As one embodiment, the above method may monitor the target signaling in time to avoid omission.

According to one aspect of the present application, the above method comprises:
the reference time is a sending time of the last PUSCH in the first PUSCH group.

According to one aspect of the present application, the above method comprises:
the second message is carried on any PUSCH in the first PUSCH group for sending.

As one embodiment, the second message is carried on the last PUSCH in the first PUSCH group for sending.

As one embodiment, the above method can indicate a more accurate cache state to the base station to avoid the mismatch between the base station scheduling and the actual transmission demand and waste of air interface resources.

According to one aspect of the present application, the above method comprises:
the second message is carried on the initial PUSCH in the first PUSCH group for sending.

As one embodiment, the above method may give an indication to the base station in time to obtain a quick scheduling and reduce transmission delay.

According to one aspect of the present application, the above method comprises:
sending a second PUSCH, the first PDCCH being used for scheduling the second PUSCH,
wherein, the second PUSCH comprises a data unit of at least a first logical channel, the at least first logical channel being allowed to be sent through the periodic time-frequency resource set.

As one embodiment, the remaining data packets that have not been transmitted through the first PUSCH group are sent through the second PUSCH dynamically scheduled by the first PDCCH, which can reduce transmission delay.

According to one aspect of the present application, the above method comprises:
the value of Q is not greater than the value of M, M being the number of PUSCH transmission occasions comprised in the first period.

As one embodiment, the value of Q is less than the value of M.

According to one aspect of the present application, the above method comprises:
a first bit block is used for generating a first PUSCH, the first bit block being associated with a first HARQ process identifier, wherein, the first PUSCH is one of all PUSCHs in the first PUSCH group, and the first HARQ process identifier is related to at least the former of a time domain resource occupied by the initial PUSCH in the first PUSCH group and a time domain position of the first PUSCH in the first PUSCH group.

As one embodiment, the above method improves the flexibility of using an HARQ (Hybrid Automatic Repeat Request) process.

As one embodiment, the above method may effectively support HARQ retransmission and combined decoding at the receiving end.

The present application discloses a method used in a second node for wireless communication, comprising:
sending a first message, the first message indicating a first period value and a periodic time-frequency resource set; and
receiving a first PUSCH group during a first period, a time-frequency resource set occupied by the first PUSCH group belonging to the periodic time-frequency resource set, the first PUSCH group comprising a second message, and the second message indicating a cache state,
wherein, a target signaling is monitored after a reference time and before a first PDCCH has been received; the first PDCCH is used for scheduling a new transmission; the first PUSCH group comprises Q PUSCHs, Q being a positive integer greater than 0; the duration of the first period is the first period value; and the reference time is related to the first PUSCH group.

According to one aspect of the present application, the above method comprises:
the reference time is a sending time of the PUSCH carrying the second message in the first PUSCH group.

According to one aspect of the present application, the above method comprises:
the reference time is a sending time of the last PUSCH in the first PUSCH group.

According to one aspect of the present application, the above method comprises:
the second message is carried on any PUSCH in the first PUSCH group for sending.

According to one aspect of the present application, the above method comprises:
the second message is carried on the initial PUSCH in the first PUSCH group for sending.

According to one aspect of the present application, the above method comprises:
sending the first PDCCH; and
receiving a second PUSCH, the first PDCCH being used for scheduling the second PUSCH,
wherein, the second PUSCH comprises a data unit of at least a first logical channel, the at least first logical channel being allowed to be sent through the periodic time-frequency resource set.

According to one aspect of the present application, the above method comprises:
the value of Q is not greater than the value of M, M being the number of PUSCH transmission occasions comprised in the first period.

According to one aspect of the present application, the above method comprises:
a first bit block is used for generating a first PUSCH, the first bit block being associated with a first HARQ process identifier, wherein, the first PUSCH is one of all PUSCHs in the first PUSCH group, and the first HARQ process identifier is related to at least the former of a time domain resource occupied by the initial PUSCH in the first PUSCH group and a time domain position of the first PUSCH in the first PUSCH group.

The present application discloses a first node used for wireless communication, comprising:
a first receiver, receiving a first message, the first message indicating a first period value and a periodic time-frequency resource set; and
a first transmitter, sending a first PUSCH group during a first period, a time-frequency resource set occupied by the first PUSCH group belonging to the periodic time-frequency resource set, the first PUSCH group comprising a second message, and the second message indicating a cache state;
the first receiver monitoring a target signaling after a reference time and before a first PDCCH has been received, the first PDCCH being used for scheduling a new transmission,
wherein, the first PUSCH group comprises Q PUSCHs, Q being a positive integer greater than 0; the duration of the first period is the first period value; and the reference time is related to the first PUSCH group.

The present application discloses a second node used for wireless communication, comprising:
a second transmitter, sending a first message, the first message indicating a first period value and a periodic time-frequency resource set; and
a second receiver, receiving a first PUSCH group during a first period, a time-frequency resource set occupied by the first PUSCH group belonging to the periodic time-frequency resource set, the first PUSCH group comprising a second message, and the second message indicating a cache state,
wherein, a target signaling is monitored after a reference time and before a first PDCCH has been received; the first PDCCH is used for scheduling a new transmission; the first PUSCH group comprises Q PUSCHs, Q being a positive integer greater than 0; the duration of the first period is the first period value; and the reference time is related to the first PUSCH group.

### BRIEF DESCRIPTION OF THE DRAWINGS

Other features, purposes and advantages of the present application will become more apparent from reading the detailed description of the non-limiting embodiments made with reference to the following drawings:

FIG. 1 illustrates a flowchart of transmission of a first node according to one embodiment of the present application;

FIG. 2 illustrates a schematic diagram of a network architecture according to one embodiment of the present application;

FIG. 3 illustrates a schematic diagram of a radio protocol architecture for a user plane and a control plane according to one embodiment of the present application;

FIG. 4 illustrates a schematic diagram of a hardware module of a communication device according to one embodiment of the present application;

FIG. 5 illustrates a flowchart of radio signal transmission according to one embodiment of the present application;

FIG. 6 illustrates a schematic diagram of a periodic time-frequency resource set according to one embodiment of the present application;

FIG. 7 illustrates a schematic diagram of a first PUSCH group and a PUSCH transmission occasion during a first period according to one embodiment of the present application;

FIG. 8 illustrates a schematic diagram of a relationship among a reference time, an active time, and a first PDCCH according to one embodiment of the present application;

FIG. 9 illustrates a schematic diagram of a relationship among another reference time, another active time, and a first PDCCH according to one embodiment of the present application;

FIG. 10 illustrates a schematic diagram of a relationship among a PUSCH carrying a second message in a first PUSCH group, a PUSCH transmission occasion, and a first PUSCH group according to one embodiment of the present application;

FIG. 11 illustrates a schematic diagram of a relationship between a PUSCH carrying a second message in another first PUSCH group and a first PUSCH group according to one embodiment of the present application;

FIG. 12 illustrates a structural diagram of a processing apparatus in a first node according to one embodiment of the present application;

FIG. 13 illustrates a structural diagram of a processing apparatus in a second node according to one embodiment of the present application.

### DETAILED DESCRIPTION OF EMBODIMENTS

The technical solution of the present application will be further described in detail below in conjunction with the drawings. It should be noted that, in the case of no conflict, embodiments and the features in the embodiments of the present application can be arbitrarily combined with each other.

### Embodiment 1

Embodiment 1 illustrates a flowchart of transmission of a first node according to one embodiment of the present application, as shown in FIG. 1.

In Embodiment 1, a first node 100 receives a first message in step 101, the first message indicating a first period value and a periodic time-frequency resource set; sends a first PUSCH group during a first period in step 102, a time-frequency resource set occupied by the first PUSCH group belonging to the periodic time-frequency resource set; and monitors a target signaling after a reference time and before a first PDCCH has been received in step 103, wherein, the first PDCCH is used for scheduling a new transmission; the first PUSCH group comprises a second message, the second message indicating a cache state; the first PUSCH group comprises Q PUSCHs, Q being a positive integer greater than 0; the duration of the first period is the first period value; and the reference time is related to the first PUSCH group.

As one embodiment, the first message is received.

As one embodiment, the first message is received via an air interface.

As one embodiment, the air interface is a Uu interface.

As one embodiment, the air interface is a PC5 interface.

As one embodiment, the first message is a high-level message.

As one embodiment, the first message is an RRC (Radio Resource Control) message.

As one embodiment, the first message comprises all or part of IEs (Information Elements) in one RRC (Radio Resource Control) signaling.

As one embodiment, the first message comprises all or part of fields in one IE (Information Element) in one RRC (Radio Resource Control) signaling.

As one embodiment, the first message is transmitted via one DL-SCH (Downlink Shared Channel).

As one embodiment, the first message is transmitted via one PDSCH (Physical Downlink Shared Channel).

As one embodiment, the first message is UE-specific.

As one embodiment, the first message is sent via unicast.

As one embodiment, the first message indicates a first period value and a periodic time-frequency resource set.

As one embodiment, the periodic time-frequency resource set is periodic in a time domain.

As one embodiment, the periodic time-frequency resource set is a periodic time-frequency resource set in the time domain.

As one embodiment, the first message indicating a first period value and a periodic time-frequency resource set comprises: the first message indicating a first period value and X time-frequency resource sets, wherein a time interval between any two adjacent time-frequency resource sets in the X time-frequency resource sets is the first period value, and X is a positive integer greater than 0.

As one embodiment, the first message indicates a start time of the periodic time-frequency resource set.

As one embodiment, the first message indicates a time domain position and a frequency domain position of the periodic time-frequency resource set in one period.

As one embodiment, the first message is used for configuring one configured grant (CG).

As one embodiment, the one configured grant is of type 1.

As one embodiment, the one configured grant is of type 2.

As one embodiment, the first message comprises a first sub-message and a second sub-message.

As one embodiment, the first sub-message is an RRC message, and the second sub-message is a PDCCH.

As one embodiment, the first sub-message is used for configuring one configured grant, and the second sub-message is used for activating the one configured grant, wherein, the one configured grant is of type 2.

As one embodiment, the first sub-message comprises the first period value; and the second sub-message indicates one time-frequency resource set, and the one time-frequency resource set appears periodically at the time interval indicated by the first period value.

As one embodiment, the first period value is the duration of at least one symbol, and the duration of the at least one symbol is related to a subcarrier spacing.

As one embodiment, the first period value is at least one millisecond (ms).

As one embodiment, the first period value is the duration of at least one slot, and the duration of the at least one slot is related to the number of symbols comprised in the one slot and the subcarrier spacing.

As one embodiment, the periodic time-frequency resource set is only used for the first type of transmission.

As one embodiment, the first type of transmission is a configured grant transmission.

As one embodiment, the first type of transmission is an uplink transmission.

As one embodiment, the first type of transmission is a configured uplink grant transmission.

As one embodiment, the first type of transmission is a transmission over a Uu interface.

As one embodiment, the first type of transmission is not used for a random access process.

As one embodiment, the first type of transmission does not comprise the sending of an Msg3 (message 3) or an MsgA (message A).

As one embodiment, the first type of transmission carries a data unit of at least a first logical channel, the at least first logical channel being configured to allow the use of the periodic time-frequency resource set.

As one embodiment, logical channel being configured to allow the use of the periodic time-frequency resource set means that the data unit of the logical channel can be mapped to the periodic time-frequency resource set.

As one embodiment, logical channel being configured to allow the use of the periodic time-frequency resource set means that the data unit of the logical channel can be sent via the periodic time-frequency resource set.

As one embodiment, the data unit is an MAC (Medium Access Control) SDU (Service Data Unit).

As one embodiment, each time-frequency resource set in the periodic time-frequency resource set corresponds to one uplink grant.

As one embodiment, each time-frequency resource in each time-frequency resource set in the periodic time-frequency resource set corresponds to one uplink grant.

As one embodiment, a first PUSCH group is sent during a first period.

As one embodiment, the duration of the first period is the first period value.

As one embodiment, the first period is not earlier than the reception of the first message.

As one embodiment, the first period comprises one time-frequency resource set in the periodic time-frequency resource set.

As one embodiment, each PUSCH in the first PUSCH group is one configured UL (uplink) transmission.

As one embodiment, each PUSCH in the first PUSCH group corresponds to one configured uplink grant.

As one embodiment, all PUSCHs in the first PUSCH group correspond to one configured uplink grant.

As one embodiment, all PUSCHs in the first PUSCH group belong to the same configured grant configuration.

As one embodiment, the phrase “a first PUSCH group is sent” comprises: each PUSCH in the first PUSCH group is sent.

As one embodiment, the phrase “a first PUSCH group is sent” comprises: a signal is sent in each PUSCH in the first PUSCH group.

As one embodiment, the phrase “a first PUSCH group is sent” comprises: at least one bit block is sent in each PUSCH in the first PUSCH group.

As one sub-embodiment of the above embodiment, the at least one bit block comprises a plurality of bits.

As one sub-embodiment of the above embodiment, the at least one bit block comprises one transport block (TB).

As one sub-embodiment of the above embodiment, the at least one bit block comprises a physical layer control signaling.

As one sub-embodiment of the above embodiment, the at least one bit block comprises an MAC sub-layer control signaling.

As one sub-embodiment of the above embodiment, the at least one bit block comprises a UCI (Uplink control information) bit.

As one sub-embodiment of the above embodiment, the at least one bit comprises an MAC CE (Control Element) As one sub-embodiment of the above embodiment, the at least one bit block comprises an MAC SDU.

As one sub-embodiment of the above embodiment, the at least one bit block comprises an MAC PDU (Protocol Data Unit).

As one embodiment, the first PUSCH group comprises a plurality of PUSCHs.

As one embodiment, the first PUSCH group comprises Q PUSCHs, Q being a positive integer greater than 0.

As one embodiment, the value of Q is less than the number of slots corresponding to the first period value.

As one embodiment, the value of Q is less than the number of slots comprised in the first period.

As one embodiment, the value of Q is not greater than 32.

As one embodiment, a time-frequency resource set occupied by the first PUSCH group belongs to the periodic time-frequency resource set.

As one embodiment, the time-frequency resource set occupied by the first PUSCH group belongs to one time-frequency resource set in the periodic time-frequency resource set.

As one embodiment, each PUSCH in the first PUSCH group occupies one time-frequency resource in one time-frequency resource set in the periodic time-frequency resource set.

As one embodiment, the first PUSCH group comprises a second message, the second message indicating a cache state.

As one embodiment, the second message is one physical layer signaling.

As one embodiment, the second message is UCI.

As one embodiment, the second message is CG (Configured Grant)-UCI.

As one embodiment, the second message comprises 1 bit.

As one embodiment, the cache state comprises two states: a logical channel configured to allow the use of the periodic time-frequency resource set has data to be transmitted and a logical channel configured to allow the use of the periodic time-frequency resource set has no data to be transmitted.

As one embodiment, the second message is one MAC CE.

As one embodiment, the second message is one BSR (buffer status report).

As one embodiment, the second message is one enhanced BSR.

As one embodiment, the cache state comprises a buffer status report.

As one embodiment, the second message comprises buffer sizes of all logical channels of the first node.

As one embodiment, the second message at least comprises a buffer size of a logical channel that the first node is configured to allow the use of the periodic time-frequency resource set.

As one embodiment, the second message only comprises a buffer size of a logical channel that the first node is configured to allow the use the periodic time-frequency resource set.

As one embodiment, if the first PUSCH group cannot completely send the cached data units of logical channels that are configured to allow the use of the periodic time-frequency resource set, the first PUSCH group comprises the second message.

As one embodiment, if after the first PUSCH group is sent, the first node still caches the data units of the logical channels that are configured to allow the use of the periodic time-frequency resource set, the first PUSCH group comprises the second message.

As one embodiment, if after the first PUSCH group is sent, the first node caches the data units of the logical channels that are not configured to allow the use of the periodic time-frequency resource set, the first PUSCH group does not comprise the second message.

As one embodiment, if after the first PUSCH group is sent, the first node caches the data units of the logical channels that are not configured to allow the use of the periodic time-frequency resource set, the first PUSCH group comprises the second message.

As one embodiment, a target signaling is monitored after a reference time and before a first PDCCH has been received, wherein, the first PDCCH is used for scheduling a new transmission.

As one embodiment, a time after the reference time and before the first PDCCH has been received is an active time.

As one embodiment, the active time is for one DRX group, and the one DRX group comprises at least one servicing cell.

As one embodiment, the target signaling is monitored on the at least one servicing cell in the one DRX group during the active time.

As one embodiment, the target signaling is a physical layer signaling.

As one embodiment, the target signaling is a PDCCH.

As one embodiment, the target signaling is DCI (Downlink Control Information).

As one embodiment, the one DRX group is configured with independent DRX parameters, the reception on the at least one servicing cell in the one DRX group is controlled by the same DRX parameters, and the DRX parameters comprise parameters related to a DRX timer.

As one embodiment, the first PDCCH is sent on the at least one servicing cell in the one DRX group.

As one embodiment, when an NDI (New Data Indication) comprised in the first PDCCH is toggled compared to an NDI comprised in one PDCCH signaling most recently received by the first node before receiving the first PDCCH, a new transmission is indicated, wherein, an HARQ (Hybrid Automatic Repeat Request) process identifier (process ID) comprised in the first PDCCH is the same as an HARQ process identifier comprised in the one PDCCH signaling most recently received before receiving the first PDCCH.

As one sub-embodiment of the above embodiment, the NDI comprised in the one PDCCH signaling most recently received before receiving the first PDCCH is 0, and the NDI comprised in the first PDCCH is 1, indicating that the NDI comprised in the first PDCCH is toggled.

As one sub-embodiment of the above embodiment, the NDI comprised in the one PDCCH signaling most recently received before receiving the first PDCCH is 1, and the NDI comprised in the first PDCCH is 0, indicating that the NDI comprised in the first PDCCH is toggled.

As one embodiment, when the first PDCCH indicates that an SPS (Semi-Persistent Scheduling) is activated, the first PDCCH is used for scheduling a new transmission.

As one embodiment, when the first PDCCH indicates that a multicast SPS is activated, the first PDCCH is used for scheduling a new transmission.

As one embodiment, when the first PDCCH indicates that a configured grant type 2 is activated, the first PDCCH is used for scheduling a new transmission.

As one embodiment, when the first PDCCH indicates that a configured sidelink grant of the configured grant type 2 is activated, the first PDCCH is used for scheduling a new transmission.

As one embodiment, a first transmission for one transport block (TB) is a new transmission.

As one embodiment, no previous NDI for one transport block is a new transmission.

As one embodiment, any transmission in a repetition for one transport block is a new transmission.

As one embodiment, a first transmission in a repetition for one transport block is a new transmission.

As one embodiment, the first PDCCH is scrambled by a C (Cell)-RNTI (Radio Network Temporary Identifier), the C-RNTI being used for identifying the first node.

As one embodiment, the first PDCCH is scrambled by a CS (Configured Scheduling)-RNTI, the CS-RNTI being used for identifying one configured grant of the first node.

As one embodiment, the first PDCCH is not scrambled by a G (Group)-RNTI, the G-RNTI being used for identifying one MBS session.

As one embodiment, the first PDCCH is not scrambled by a G (Group)-CS (Configured Scheduling)-RNTI, the G-CS-RNTI being used for identifying one configured grant of one MBS (multicast/broadcast service) session.

As one embodiment, the first PDCCH is not scrambled by an RA (Random Access)-RNTI, the RA-RNTI being used for identifying a group of UE, the RA-RNTI being related to a time-frequency resource where a random preamble is sent, and the RA-RNTI being used for random access response.

As one embodiment, the first PDCCH is not scrambled by an MSGB (message B)-RNTI, the MSGB-RNTI being used for identifying a group of UE, the MSGB-RNTI being related to a time-frequency resource where an MsgA (message A) is sent, and the MSGB-RNTI being used for random access response in a 2-step random access type.

As one embodiment, the first PDCCH is used for scheduling a downlink new transmission.

As one embodiment, the first PDCCH is used for scheduling an uplink new transmission.

As one embodiment, the first PDCCH is used for scheduling a sidelink new transmission.

As one embodiment, the first PDCCH is used for scheduling a new transmission on the at least one serving cell in the one DRX group.

As one embodiment, decoding is performed on the first PDCCH, and whether the decoding is correct is determined according to CRC (Cyclic Redundancy Check) verification, if the CRC verification fails, the first PDCCH is not received, and if the CRC verification is passed, the first PDCCH is received.

As one embodiment, the meaning of “monitoring a target signaling” comprises searching for the target signaling.

As one embodiment, the meaning of “monitoring a target signaling” comprises monitoring the target signaling.

As one embodiment, the phrase “monitoring a target signaling” comprises: determining whether the target signaling exists through energy monitoring.

As one embodiment, the phrase “monitoring a target signaling” comprises: determining whether the target signaling exists through coherent detection.

As one embodiment, the phrase “monitoring a target signaling” comprises: determining whether the target signaling exists through broadband detection.

As one embodiment, the phrase “monitoring a target signaling” comprises: determining whether the target signaling exists through maximum likelihood detection.

As one embodiment, the phrase “monitoring a target signaling” comprises: determining whether the target signaling exists through blind decoding detection.

As one embodiment, the phrase “monitoring a target signaling” comprises: performing CRC verification, determining that the target signaling is monitored if the CRC verification is passed, and determining that the target signaling is not monitored if the CRC verification fails.

As one embodiment, the target signaling is monitored in a first time-frequency resource pool; and the first time-frequency resource pool is allocated to a first search space.

As one embodiment, the first time-frequency resource pool is configured on the at least one servicing cell comprised in the one DRX group.

As one embodiment, the first time-frequency resource pool comprises at least one RE (Resource Element).

As one embodiment, the first time-frequency resource pool comprises a plurality of CCEs (Control Chanel Elements).

As one embodiment, the first time-frequency resource pool comprises a segment of continuous time domain resources.

As one embodiment, the first time-frequency resource pool comprises a segment of discontinuous time domain resources.

As one embodiment, the first time-frequency resource pool comprises a segment of continuous frequency domain resources.

As one embodiment, the first time-frequency resource pool comprises a segment of discontinuous frequency domain resources.

As one embodiment, the first time-frequency resource pool is configured through an RRC message.

As one embodiment, the first time-frequency resource pool is used for configuring a control resource set (CORESET) for monitoring the target signaling.

As one embodiment, the first search space comprises a CSS (Common search space) set.

As one embodiment, the first search space comprises a USS (UE-specific search space) set.

As one embodiment, the first search space comprises a Type0-PDCCH CSS set.

As one embodiment, the first search space comprises a Type0A-PDCCH CSS set.

As one embodiment, the first search space comprises a Type1-PDCCH CSS set.

As one embodiment, the first search space comprises a Type2-PDCCH CSS set.

As one embodiment, the first search space comprises a Type3-PDCCH CSS set.

As one embodiment, the first search space is used for searching for a PDCCH candidate.

As one embodiment, the first node abandons monitoring the target signaling during an inactive time.

As one embodiment, the active time comprises a time when a first timer is in a running state, the first timer being configured to the one DRX group.

As one embodiment, the first timer is one of a drx-onDuration Timer (discontinuous reception-on Duration Timer), or a drx-Inactivity Timer (discontinuous reception-Inactivity Timer), or a drx-Retransmission TimerDL (discontinuous reception-Retransmission Timer Downlink), or a drx-Retransmission TimerUL (discontinuous reception-Retransmission Timer Uplink), or a drx-RetransmissionTimerSL (discontinuous reception-Retransmission Timer Sidelink).

As one embodiment, the first timer is a ra-ContentionResolution Timer (random access-Contention Resolution Timer), or an msgB-ResponseWindow (message B-Response Window).

As one embodiment, the first timer is maintained on an MAC sub-layer of the first node.

As one embodiment, the reference time is related to the first PUSCH group.

As one embodiment, the reference time is not earlier than a sending time of any PUSCH in the first PUSCH group.

As one embodiment, the reference time is a sending time of the initial PUSCH in the first PUSCH group.

As one embodiment, the initial PUSCH in the first PUSCH group is a first PUSCH in the first PUSCH group.

As one embodiment, a sending time of one PUSCH comprises: an OFDM (Orthogonal Frequency Division Multiplexing) symbol occupied by one PUSCH.

As one embodiment, a sending time of one PUSCH comprises: a slot occupied by one PUSCH.

As one embodiment, a sending time of one PUSCH comprises: an end time of the last OFDM symbol occupied by one PUSCH.

As one embodiment, a sending time of one PUSCH comprises: an end time of the last slot occupied by one PUSCH.

As one embodiment, a sending time of one PUSCH comprises: a start time of the first OFDM symbol occupied by one PUSCH.

As one embodiment, a sending time of one PUSCH comprises: a start time of the first slot occupied by one PUSCH.

As one embodiment, the reference time is the kth OFDM symbol after a sending end time of the first PUSCH group, k being preconfigured, or k being a constant, and k being an integer not less than 0.

As one embodiment, the reference time is an earliest first symbol of CORRESET configured to the first node for receiving a PDCCH for a Type-1-PDCCH CSS set after the sending end time of the first PUSCH group.

### Embodiment 2

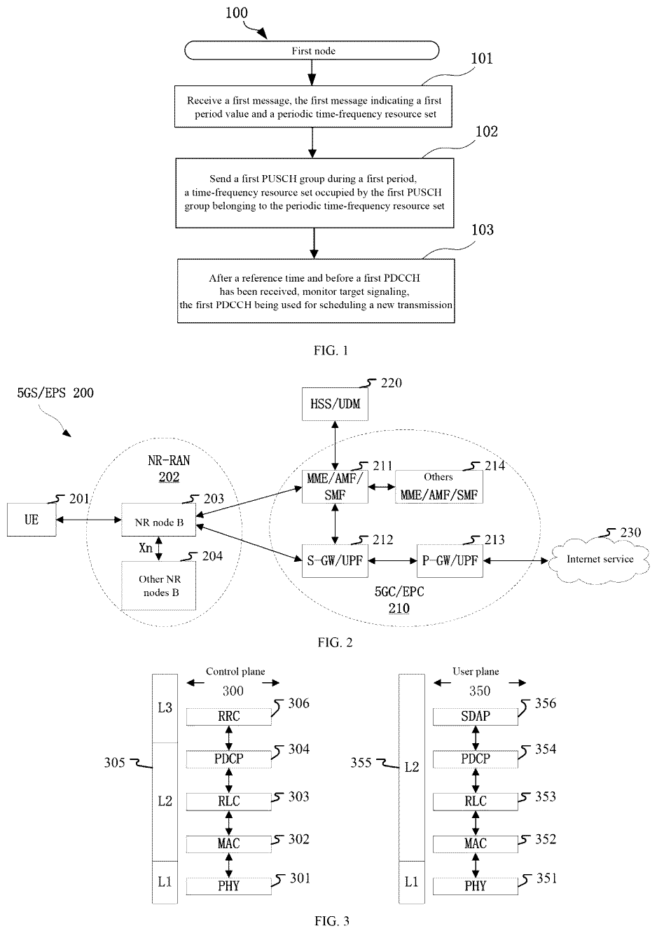

Embodiment 2 illustrates a schematic diagram of a network architecture according to one embodiment of the present application, as shown in FIG. 2. FIG. 2 illustrates a network architecture 200 of NR 5G, LTE (Long-Term Evolution) and LTE-A (Long-Term Evolution Advanced) systems. The NR 5G, LTE or LTE-A network architecture 200 may be referred to as a 5GS (5G System)/EPS (Evolved Packet System) 200 or some other suitable terminologies. The 5GS/EPS 200 may comprise one or more pieces of UE (User Equipment) 201, an NG-RAN (Next Generation Radio Access Network) 202, a 5GC (5G Core Network)/EPC (Evolved Packet Core) 210, an HSS (Home Subscriber Server)/UDM (Unified Data Management) 220, and an Internet service 230. The 5GS/EPS may be interconnected with other access networks, but these entities/interfaces are not shown for simplicity. As shown, the 5GS/EPS provides packet switching services, but those skilled in the art will readily appreciate that the various concepts presented throughout the present application may be extended to networks that provide circuit switching services or other cellular networks. The NG-RAN comprises an NR Node B (gNB) 203 and other gNBs 204. The gNB203 provides user and control plane protocol terminations toward the UE201. The gNB203 may be connected to other gNBs 204 via an Xn interface (e.g., backhaul link). The XnAP protocol of the Xn interface is used for transmitting control plane messages of a radio network, and the user plane protocol of the Xn interface is used for transmitting user plane data. The gNB 203 may also be referred to as a base station, a base transceiving station, a radio base station, a radio transceiving device, a transceiving device function, a basic service set (BSS), an extended service set (ESS), a TRP (Transmitter Receiver Point), or some other suitable terminologies, and in an NTN (Non Terrestrial Network), the gNB 203 may be a satellite, an aircraft, or a terrestrial base station relayed via the satellite. The gNB 203 provides an access point to the 5GC/EPC 210 for the UE 201. Examples of the UE 201 comprise a cellular phone, a smart phone, a session initiation protocol (SIP) phone, a laptop, a personal digital assistant (PDA), a satellite radio, a global positioning system, a multimedia apparatus, a video apparatus, a digital audio player (e.g., an MP3 player), a camera, a game console, a drone, an aircraft, a narrowband Internet of Things device, a machine type communication device, a land vehicle, an automobile, a vehicle-mounted device, a vehicle-mounted communication unit, a wearable device, or any other similarly functional apparatuses. Those skilled in the art may also refer to the UE 201 as a mobile station, a subscriber station, a mobile unit, a subscriber unit, a wireless unit, a remote unit, a mobile apparatus, a wireless apparatus, a wireless communication apparatus, a remote apparatus, a mobile subscriber station, an access terminal, a mobile terminal, a wireless terminal, a remote terminal, a handset, a user agent, a mobile client, a client, or some other suitable terminologies. The gNB203 is connected to the 5GC/EPC210 via an S1/NG interface. The 5GC/EPC 210 comprises an MME (Mobility Management Entity)/AMF (Authentication Management Field)/SMF (Session Management Function) 211, other MMEs/AMFs/SMFs 214, an S-GW (Service Gateway)/UPF (User Plane Function) 212, and a P-GW (Packet Data Network Gateway)/UPF 213. The MME/AMF/SMF 211 is a control node that processes a signaling between the UE 201 and the 5GC/EPC 210. Generally, the MME/AMF/SMF 211 provides bearer and connection management. All user IP (Internet Protocol) packets are transmitted via the S-GW/UPF 212, the S-GW/UPF 212 being itself connected to the P-GW/UPF 213. The P-GW provides UE IP address allocation and other functions. The P-GW/UPF 213 is connected to the Internet service 230. The Internet service 230 comprises operator-corresponding Internet Protocol services, which may specifically comprise the Internet, an intranet, an IMS (IP Multimedia Subsystem), and a packet switching (PS) streaming service.

As one embodiment, the UE 201 corresponds to a first node in the present application.

As one embodiment, the gNB 203 corresponds to a second node in the present application.

As one embodiment, the UE 201 is user equipment.

As one embodiment, the UE 201 is Layer 2 U2N remote UE.

As one embodiment, the UE 201 is a V2X terminal.

As one embodiment, the gNB 203 is a Macro Cell base station.

As one embodiment, the gNB 203 is a Micro Cell base station.

As one embodiment, the gNB 203 is a Pico Cell base station.

As one embodiment, the gNB 203 is a Femtocell.

As one embodiment, the gNB 203 is a base station device supporting a large-latency difference.

As one embodiment, the gNB 203 is one flying platform device.

As one embodiment, the gNB 203 is a satellite device.

As one embodiment, the gNB 203 is a test device (such as a transceiving apparatus that simulates some functions of a base station, and a signaling tester).

As one embodiment, a radio link from the UE201 to the gNB 203 is an uplink, the uplink being used for executing uplink transmission.

As one embodiment, the radio link from the gNB 203 to the UE 201 is a downlink, the downlink being used for executing downlink transmission.

As one embodiment, the UE 201 and the gNB 203 are connected via a Uu air interface.

### Embodiment 3

Embodiment 3 illustrates a schematic diagram of a radio protocol architecture for a user plane and a control plane according to one embodiment of the present application, as shown in FIG. 3. FIG. 3 is a schematic diagram illustrating an embodiment of a radio protocol architecture for a user plane 350 and a control plane 300. FIG. 3 shows the radio protocol architecture for the control plane 300 for UE and gNBs using three layers: a Layer 1, a Layer 2, and a Layer 3. The Layer 1 (L1 layer) is the lowest layer and implements various PHY (physical layer) signal processing functions. The L1 layer will be referred to as a PHY 301 herein. The Layer 2 (L2 layer) 305 is above PHY 301 and is responsible for the link between UE and gNBs through the PHY 301. The L2 layer 305 comprises an MAC (Medium Access Control) sub-layer 302, an RLC (Radio Link Control) sub-layer 303, and a PDCP (Packet Data Convergence Protocol) sub-layer 304, which terminate at the gNB of the network side. The PDCP sub-layer 304 provides data encryption and integrity protection, and the PDCP sub-layer 304 also provides inter-cell mobility support of UE between gNBs. The RLC sub-layer 303 provides data packet segmentation and reassembly, and retransmits lost data packets through an ARQ (Automatic Repeat Request). The RLC sub-layer 303 also provides duplicate data packet detection and protocol error detection. The MAC sub-layer 302 provides mapping between a logical channel and a transport channel and multiplexing of the logical channel. The MAC sub-layer 302 is also responsible for allocating various radio resources (e.g., resource blocks) in one cell between UE. The MAC sub-layer 302 is also responsible for HARQ (Hybrid Automatic Repeat Request) operations. An RRC (Radio Resource Control) sub-layer 306 in the Layer 3 (L3 layer) in the control plane 300 is responsible for obtaining radio resources (i.e., radio bearers) and configuring lower layers using an RRC signaling between a gNB and UE. The radio protocol architecture for the user plane 350 comprises a Layer 1 (L1 layer) and a Layer 2 (L2 layer). The radio protocol architecture in the user plane 350 is substantially the same as the corresponding layers and sub-layers in the control plane 300 for a physical layer 351, a PDCP sub-layer 354 in an L2 layer 355, an RLC sub-layer 353 in the L2 layer 355, and an MAC sub-layer 352 in the L2 layer 355, but the PDCP sub-layer 354 also provides header compression for the upper-layer data packets to reduce radio transmission overhead. The L2 layer 355 in the user plane 350 also comprises an SDAP (Service Data Adaptation Protocol) sub-layer 356, and the SDAP sub-layer 356 is responsible for mapping between a QoS flow and a data radio bearer (DRB) to support the diversity of services. The radio protocol architecture of the UE in the user plane 350 may comprise an SDAP sub-layer 356, the PDCP sub-layer 354, the RLC sub-layer 353 and part or all of the protocol sub-layers of the MAC sub-layer 352 in the L2 layer. Although not shown in the figure, the UE may have several upper layers above the L2 layer 355, comprising a network layer (e.g., an IP layer) terminating at the P-GW on the network side and an application layer terminating at the other end of the connection (e.g., remote UE and a server).

As one embodiment, the radio protocol architecture in FIG. 3 is applicable to a first node in the present application.

As one embodiment, the radio protocol architecture in FIG. 3 is applicable to a second node in the present application.

As one embodiment, the first message in the present application is generated at the RRC 306.

As one embodiment, the first message in the present application is generated at the PHY 301 or the PHY 351.

As one embodiment, the second message in the present application is generated at the PHY 301 or the PHY 351.

As one embodiment, the second message in the present application is generated at the MAC 302 or the MAC 352.

As one embodiment, the first PUSCH group in the present application is generated at the PHY 301 or the PHY 351.

As one embodiment, the first PDCCH in the present application is generated at the PHY 301 or the PHY 351.

As one embodiment, the target signaling in the present application is generated at the PHY 301 or the PHY351.

As one embodiment, the second PUSCH in the present application is generated at the PHY 301 or the PHY 351.

As one embodiment, the L2 layer 305 belongs to a higher layer.

As one embodiment, an RRC sub-layer 306 in the L3 layer belongs to a higher layer.

As one embodiment, an MAC sub-layer provides data transmission services through logical channels.

As one embodiment, the MAC sub-layer multiplexes data units from one or more logical channels into one TB and then transmits the one TB to a physical layer through a transport channel.

As one embodiment, the MAC sub-layer demultiplexes one TB transmitted from the physical layer through the transport channel into data units of one or more logical channels.

### Embodiment 4

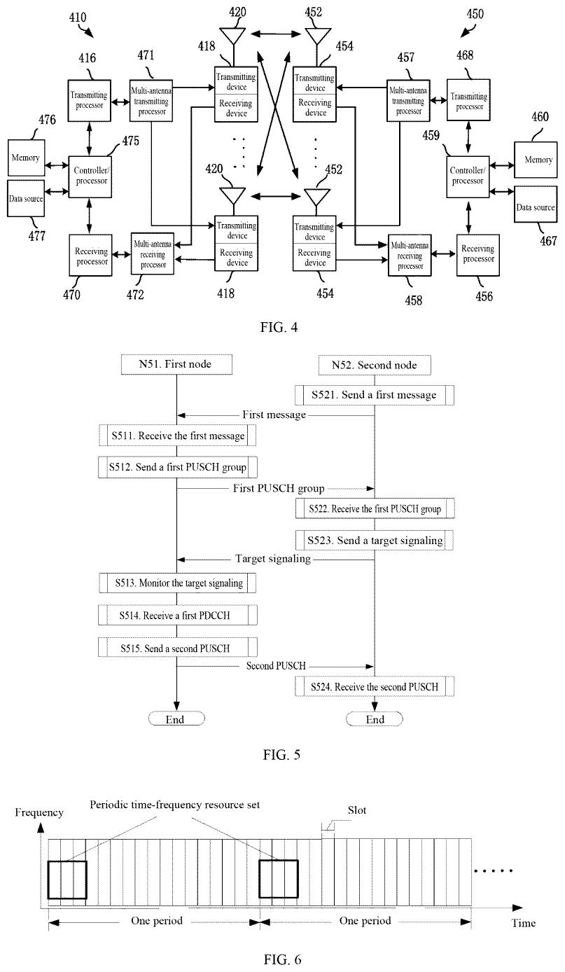

Embodiment 4 illustrates a schematic diagram of a hardware module of a communication device according to one embodiment of the present application, as shown in FIG. 4. FIG. 4 is a block diagram of a first communication device 450 and a second communication device 410 communicating with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitting device/receiving device 454, and an antenna 452.

The second communication device 410 comprises a controller/processor 475, a memory 476, a data resource 477, a receiving processor 470, a transmitting processor 416, a multi-antenna receiving processor 472, a multi-antenna transmitting processor 471, a transmitting device/receiving device 418, and an antenna 420.

In transmission from the second communication device 410 to the first communication device 450, at the second communication device 410, upper-layer data packets from a core network or upper-layer data packets from the data source 477 are provided to the controller/processor 475. The core network and the data source 477 represent all protocol layers above the L2 layer. The controller/processor 475 implements the functionality of the L2 layer. In the transmission from the second communication device 410 to the first communication device 450, the controller/processor 475 provides header compression, encryption, packet segmentation and reordering, multiplexing between logical and transport channels, and radio resource allocation to the first communication device 450 based on various priority metrics. The controller/processor 475 is also responsible for retransmission of lost packets and signalings to the first communication device 450. The transmitting processor 416 and the multi-antenna transmitting processor 471 implement various signal processing functions for an L1 layer (i.e., a physical layer). The transmitting processor 416 implements coding and interleaving to facilitate forward error correction (FEC) at the second communication device 410, as well as mapping of signal constellations based on various modulation schemes (e.g., binary phase shift keying (BPSK), quadrature phase shift keying (QPSK), M-phase shift keying (M-PSK), and M-quadrature amplitude modulation (M-QAM). The multi-antenna transmitting processor 471 performs digital spatial precoding, comprising codebook-based precoding and non-codebook-based precoding, and beamforming processing to generate one or more spatial streams. The transmitting processor 416 then maps each spatial stream to a subcarrier, multiplexes the each spatial stream with a reference signal (e.g., pilot frequency) in a time domain and/or frequency domain, and then uses an inverse fast Fourier transform (IFFT) to produce a physical channel carrying a time-domain multi-carrier symbol stream. The multi-antenna transmitting processor 471 then performs a sending analog precoding/beamforming operation on the time-domain multi-carrier symbol stream. Each transmitting device 418 converts a baseband multi-carrier symbol stream provided by the multi-antenna transmitting processor 471 into a radio frequency stream, and then provides the radio frequency stream to different antennas 420.

In the transmission from the second communication device 410 to the first communication device 450, at the first communication device 450, each receiving device 454 receives a signal through a corresponding antenna 452 thereof. Each receiving device 454 recovers information modulated onto a radio frequency carrier, and converts the radio frequency stream into a baseband multi-carrier symbol stream and provides the baseband multi-carrier symbol stream to the receiving processor 456. The receiving processor 456 and the multi-antenna receiving processor 458 implement various signal processing functions of the L1 layer. The multi-antenna receiving processor 458 performs a receiving analog precoding/beamforming operation on the baseband multi-carrier symbol stream from the receiving device 454. The receiving processor 456 uses a fast Fourier transform (FFT) to convert the baseband multi-carrier symbol stream from a time domain to a frequency domain after the receiving analog precoding/beamforming operation. In the frequency domain, the physical layer data signal and the reference signal are demultiplexed by the receiving processor 456, wherein the reference signal will be used for channel estimation, and the data signal is recovered after multi-antenna detection in the multi-antenna receiving processor 458 to recover any spatial stream destined for the first communication device 450. The symbols on each spatial stream are demodulated and recovered in the receiving processor 456, and soft decisions are generated. The receiving processor 456 then decodes and deinterleaves the soft decisions to recover upper-layer data and control signals transmitted by the second communication device 410 on the physical channel. The upper-layer data and control signals are then provided to the controller/processor 459. The controller/processor 459 implements the functions of the L2 layer. The controller/processor 459 may be associated with the memory 460 storing program codes and data. The memory 460 may be referred to as a computer-readable medium. In the transmission from the second communication device 410 to the first communication device 450, the controller/processor 459 provides demultiplexing between transport and logical channels, packet reassembly, decryption, header decompression, and control signal processing to recover higher-layer data packets from the second communication device 410. The upper-layer data packets are then provided to all protocol layers above the L2 layer. Various control signals may also be provided to an L3 for L3 processing.

In transmission from the first communication device 450 to the second communication device 410, at the first communication device 450, the upper-layer data packets are provided to the controller/processor 459 using the data source 467. The data source 467 represents all protocol layers above the L2 layer. Similar to the sending function at the second communication device 410 described in the transmission from the second communication device 410 to the first communication device 450, the controller/processor 459 implements header compression, encryption, packet segmentation and reordering, and multiplexing between logical and transport channels, and implements the functions of the L2 layer for the user plane and the control plane. The controller/processor 459 is also responsible for retransmission of lost packets and signalings to the second communication device 410. The transmitting processor 468 performs modulation mapping and channel coding processing, and the multi-antenna transmitting processor 457 performs digital multi-antenna spatial precoding, comprising codebook-based precoding and non-codebook-based precoding, and beamforming processing. Then, the transmitting processor 468 modulates the produced spatial stream into a multi-carrier/single-carrier symbol stream, which is provided to different antennas 452 by the transmitting device 454 after analog precoding/beamforming operations in the multi-antenna transmitting processor 457. Each transmitting device 454 first converts the baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiving device 418 receives a radio frequency signal through a corresponding antenna 420 thereof, converts the received radio frequency signal into a baseband signal, and provides the baseband signal to the multi-antenna receiving processor 472 and the receiving processor 470. The receiving processor 470 and the multi-antenna receiving processor 472 jointly implement the functions of the L1 layer. The controller/processor 475 implements the functions of the L2 layer. The controller/processor 475 may be associated with the memory 476 storing program codes and data. The memory 476 may be referred to as a computer-readable medium. In the transmission from the first communication device 450 to the second communication device 410, the controller/processor 475 provides demultiplexing between transport and logical channels, packet reassembly, decryption, header decompression, and control signal processing to recover upper-layer data packets from the first communication device 450. The upper-layer data packets from the controller/processor 475 may be provided to the core network or all protocol layers above the L2 layer, and various control signals may also be provided to the core network or the L3 for L3 processing.

As one embodiment, the first communication device 450 apparatus comprises: at least one processor and at least one memory, wherein the at least one memory comprises a computer program code; the at least one memory and the computer program code are configured to be used together with the at least one processor; and the first communication device 450 apparatus at least: receives a first message, the first message indicating a first period value and a periodic time-frequency resource set; sends a first PUSCH group during a first period, a time-frequency resource set occupied by the first PUSCH group belonging to the periodic time-frequency resource set, the first PUSCH group comprising a second message, and the second message indicating a cache state; and monitors a target signaling after a reference time and before a first PDCCH has been received, the first PDCCH being used for scheduling a new transmission, wherein, the first PUSCH group comprises Q PUSCHs, Q being a positive integer greater than 0; the duration of the first period is the first period value; and the reference time is related to the first PUSCH group.

As one embodiment, the first communication device 450 apparatus comprises: a memory storing a computer-readable instruction program, the computer-readable instruction program generating actions when executed by at least one processor, the actions comprising: receiving a first message, the first message indicating a first period value and a periodic time-frequency resource set; sending a first PUSCH group during a first period, a time-frequency resource set occupied by the first PUSCH group belonging to the periodic time-frequency resource set, the first PUSCH group comprising a second message, and the second message indicating a cache state; and monitoring a target signaling after a reference time and before a first PDCCH has been received, the first PDCCH being used for scheduling a new transmission, wherein, the first PUSCH group comprises Q PUSCHs, Q being a positive integer greater than 0; the duration of the first period is the first period value; and the reference time is related to the first PUSCH group.

As one embodiment, the second communication device 410 apparatus comprises: at least one processor and at least one memory, wherein the at least one memory comprises a computer program code; the at least one memory and the computer program code are configured to be used together with the at least one processor; and the second communication device 410 apparatus at least: sends a first message, the first message indicating a first period value and a periodic time-frequency resource set; and receives a first PUSCH group during a first period, a time-frequency resource set occupied by the first PUSCH group belonging to the periodic time-frequency resource set, the first PUSCH group comprising a second message, and the second message indicating a cache state, wherein, a target signaling is monitored after a reference time and before a first PDCCH has been received, the first PDCCH being used for scheduling a new transmission, wherein the first PUSCH group comprises Q PUSCHs, Q being a positive integer greater than 0; the duration of the first period is the first period value; and the reference time is related to the first PUSCH group.

As one embodiment, the second communication device 410 apparatus comprises: a memory storing a computer-readable instruction program, the computer-readable instruction program generating actions when executed by at least one processor, the actions comprising: sending a first message, the first message indicating a first period value and a periodic time-frequency resource set; and receiving a first PUSCH group during a first period, a time-frequency resource set occupied by the first PUSCH group belonging to the periodic time-frequency resource set, the first PUSCH group comprising a second message, and the second message indicating a cache state, wherein, a target signaling is monitored after a reference time and before a first PDCCH has been received, the first PDCCH being used for scheduling a new transmission; the first PUSCH group comprises Q PUSCHs, Q being a positive integer greater than 0; the duration of the first period is the first period value; and the reference time is related to the first PUSCH group.

As one embodiment, the first communication device 450 corresponds to a first node in the present application.

As one embodiment, the second communication device 410 corresponds to a second node in the present application.

As one embodiment, the first communication device 450 is a piece of UE.

As one embodiment, the first communication device 450 is a piece of Layer 2 U2N remote UE.

As one embodiment, the first communication device 450 is a Layer 3 relay node.

As one embodiment, the second communication device 410 is one base station.

As one embodiment, at least one of the antenna 420, the transmitting device 418, the multi-antenna transmitting processor 471, the transmitting processor 416, or the controller/processor 475 is used for sending a first message in the present application.

As one embodiment, at least one of the antenna 452, the receiving device 454, the multi-antenna receiving processor 458, the receiving processor 456, or the controller/processor 459 is used for receiving the first message in the present application.

As one embodiment, at least one of the antenna 452, the transmitting device 454, the multi-antenna transmitting processor 457, the transmitting processor 468, or the controller/processor 459 is used for sending a first PUSCH group in the present application.

As one embodiment, at least one of the antenna 420, the receiving device 418, the multi-antenna receiving processor 472, the receiving processor 470, or the controller/processor 475 is used for receiving the first PUSCH group in the present application.

As one embodiment, at least one of the antenna 420, the transmitting device 418, the multi-antenna transmitting processor 471, the transmitting processor 416, or the controller/processor 475 is used for sending a first PDCCH in the present application.

As one embodiment, at least one of the antenna 452, the receiving device 454, the multi-antenna receiving processor 458, the receiving processor 456, or the controller/processor 459 is used for receiving the first PDCCH in the present application.

As one embodiment, at least one of the antenna 420, the transmitting device 418, the multi-antenna transmitting processor 471, the transmitting processor 416, or the controller/processor 475 is used for sending a target signaling in the present application.

As one embodiment, at least one of the antenna 452, the receiving device 454, the multi-antenna receiving processor 458, the receiving processor 456, or the controller/processor 459 is used for monitoring the target signaling in the present application.

As one embodiment, at least one of the antenna 452, the transmitting device 454, the multi-antenna transmitting processor 457, the transmitting processor 468, or the controller/processor 459 is used for sending a second PUSCH in the present application.

As one embodiment, at least one of the antenna 420, the receiving device 418, the multi-antenna receiving processor 472, the receiving processor 470, or the controller/processor 475 is used for receiving the second PUSCH in the present application.

### Embodiment 5

Embodiment 5 illustrates a flowchart of radio signal transmission according to one embodiment of the present application, as shown in FIG. 5. In FIG. 5, a first node N51 and a second node N52 are communicated via an air interface. It should be particularly noted that the order in this example does not limit the signal transmission order and implementation order in the present application.

For the first node N51, a first message is received in step S511; a first PUSCH group is sent in step S512; a target signaling is monitored in step S513; a first PDCCH is received in step S514; and a second PUSCH is sent in step S515.

For the second node N52, the first message is sent in step S521; the first PUSCH group is received in step S522; the target signaling is sent in step S523; and the second PUSCH is received in step S524.

In Embodiment 5, a first message is received, the first message indicating a first period value and a periodic time-frequency resource set; a first transmitter sends a first PUSCH group during a first period, a time-frequency resource set occupied by the first PUSCH group belonging to the periodic time-frequency resource set, the first PUSCH group comprising a second message, and the second message indicating a cache state; the first receiver monitors a target signaling after a reference time and before a first PDCCH has been received, the first PDCCH being used for scheduling a new transmission, wherein, the first PUSCH group comprises Q PUSCHs, Q being a positive integer greater than 0; the duration of the first period is the first period value; the reference time is related to the first PUSCH group; a second PUSCH is sent, the first PDCCH being used for scheduling the second PUSCH, wherein, the second PUSCH comprises a data unit of at least a first logical channel, the at least first logical channel being allowed to be sent through the periodic time-frequency resource set; and a first bit block is used for generating a first PUSCH, the first bit block being associated with a first HARQ process identifier, wherein, the first PUSCH is one of all PUSCHs in the first PUSCH group, and the first HARQ process identifier is related to a time domain position of the first PUSCH in the first PUSCH group.

It should be noted that step S512 may comprise a plurality of PUSCHs, and step S513 may be executed between the plurality of PUSCHs.

As one embodiment, the second node N52 is a maintenance base station of a serving cell of the first node N51.

As one embodiment, the second node N52 is a TRP (Transmitter/Receiver Point) of a serving cell of the first node N51.

As one embodiment, the second node N52 is a maintenance base station of a master cell group (MCG) of the first node N51.

As one embodiment, the second node N52 is a maintenance base station of a secondary cell group (SCG) of the first node N51.

As one embodiment, the second node N52 is a maintenance base station of a primary cell of the first node N51.

As one embodiment, the second node N52 is a maintenance base station of a secondary cell of the first node N51.

As one embodiment, the second node N52 is a maintenance base station of a special cell (SpCell) of the first node N51.

As one embodiment, the second node N52 is a maintenance base station of the at least one serving cell in the one DRX group.

As one embodiment, the first PDCCH is received during the active time.

As one embodiment, the first PDCCH belongs to the target signaling.

As one embodiment, the first PDCCH is the target signaling.

As one embodiment, the first PDCCH is a dynamic scheduling signaling.

As one embodiment, the first PDCCH is used for scheduling a second PUSCH.

As one embodiment, the first PDCCH indicates parameters for sending the second PUSCH, the parameters comprising at least one of a process identifier, a time-frequency resource, an MCS and an NDI.

As one embodiment, the second PUSCH does not belong to the first PUSCH group.

As one embodiment, a sending time of the second PUSCH is later than a sending time of the first PUSCH group.

As one embodiment, the sending time of the second PUSCH is earlier than a start time of time domain resources occupied by a periodic time-frequency resource set comprised in one period immediately following the first period.

As one embodiment, the second PUSCH comprises a first transmission of one bit block.

As one embodiment, an HARQ process identifier corresponding to the bit block comprised in the second PUSCH is different from an HARQ process identifier corresponding to the bit block comprised in any PUSCH in the first PUSCH group.

As one embodiment, the second PUSCH comprises a data unit of at least a first logical channel.

As one embodiment, the second PUSCH only comprises the data unit of at least the first logical channel.

As one embodiment, the second PUSCH comprises the data unit of a second logical channel, and the second logical channel does not belong to the at least first logical channel.

As one embodiment, the data unit comprises an SDU.

As one embodiment, the data unit comprises an MAC SDU.

As one embodiment, the data unit comprises an RLC (Radio Link Control) PDU.

As one embodiment, the data unit comprises at least 1 bit.

As one embodiment, the data unit comprises at least 1 byte.

As one embodiment, the at least first logical channel is allowed to be sent through the periodic time-frequency resource set.

As one embodiment, the phrase “the second logical channel does not belong to the at least first logical channel” comprises: the second logical channel is not configured to allow the sending through the periodic time-frequency resource set.

As one embodiment, the first PDCCH is a first PDCCH received for scheduling a new transmission after sending the second message.

As one embodiment, an uplink grant indicated by the first PDCCH is only used for the sending of the data unit of the at least first logical channel.

As one embodiment, the uplink grant indicated by the first PDCCH is preferentially used for the sending of the data unit of the at least first logical channel.

As one embodiment, a radio bearer served by the at least first logical channel is mapped to at least one PDU set.

As one embodiment, a first bit block is used for generating a first PUSCH, wherein, the first PUSCH is one of all PUSCHs in the first PUSCH group.

As one embodiment, the first bit block is one of Q bit blocks.

As one embodiment, any two bit blocks in the Q bit blocks at least comprise 1 bit that is different.

As one embodiment, the first bit block comprises at least 1 bit.

As one embodiment, the phrase “a first bit block is used for generating a first PUSCH” comprises: a first bit block undergoes at least some of CRC attachment, code block segmentation, code block CRC attachment, channel coding, rate matching, code block concatenation, scrambling, modulation, layer mapping, transform precoding, precoding, mapping to virtual resource blocks, mapping from virtual to physical resource blocks, multi-carrier symbol generation, and modulation and up-conversion to generate a first PUSCH.

As one embodiment, the first PUSCH comprises one radio signal.

As one embodiment, the first bit block is associated with a first HARQ process identifier (process ID).

As one embodiment, the first HARQ process identifier is a non-negative integer smaller than nrofHARQ-Processes (number of HARQ processes), the first message indicating the nrofHARQ-Processes.

As one embodiment, the nrofHARQ-Processes is the number of HARQ processes applied to configured grants corresponding to the periodic time-frequency resource set.

As one embodiment, the first HARQ process identifier is related to at least the former of a time domain resource occupied by the initial PUSCH in the first PUSCH group and a time domain position of the first PUSCH in the first PUSCH group.

As one embodiment, when the first PUSCH is the initial PUSCH in the first PUSCH group, the first HARQ process identifier is only related to the time domain resource occupied by the first PUSCH.

As one embodiment, when the first PUSCH is the initial PUSCH in the first PUSCH group, the first HARQ process identifier is associated with a first symbol occupied by the first PUSCH.

As one embodiment, when the first PUSCH is the initial PUSCH in the first PUSCH group, the first HARQ process identifier is [floor(CURRENT_symbol/periodicity)] modulo nrofHARQ-Processes, wherein, the first message does not comprise a harq-ProcID-Offset2, and the first message does not comprise a cg-Retransmission Timer, and wherein, the floor (·) is a rounding down operation; and the modulo is a modulo operation.

As one embodiment, when the first PUSCH is the initial PUSCH in the first PUSCH group, the first HARQ process identifier is [floor(CURRENT_symbol/periodicity)] modulo nrofHARQ-Processes+harq-ProcID-Offset2, wherein, the first message comprises the harq-ProcID-Offset2, and wherein, the floor (·) is a rounding-down operation; and the modulo is a modulo operation.

As one sub-embodiment of the above two embodiments, the CURRENT_symbol=(SFN×numberOfSlotsPerFrame×numberOfSymbolsPerSlot+slot number in the frame×numberOfSymbolsPerSlot+symbol number in the slot), wherein, the SFN (System Frame Number) is a system frame number where the first PUSCH is located, the numberOfSlotsPerFrame is the number of slots comprised in one frame, the numberOfSymbolsPerSlot is the number of symbols comprised in one slot, the slot number in the frame is a slot number of the first PUSCH in the system frame, and the symbol number in the slot is a first symbol of the first PUSCH in the slot.

As one embodiment, the periodicity (periodicity) is the first period value.

As one embodiment, the nrofHARQ-Processes is the number of HARQ processes applied to configured grants corresponding to the periodic time-frequency resource set.

As one embodiment, the harq-ProcID-Offset2 (HARQ process identifier offset 2) is an HARQ process identifier offset.

As one embodiment, the cg-Retransmission Timer is a configured grant retransmission timer.

As one embodiment, when the first PUSCH is not the initial PUSCH in the first PUSCH group, the first HARQ process identifier is related to the time domain resource occupied by the initial PUSCH in the first PUSCH group and the time domain position of the first PUSCH in the first PUSCH group.

As one embodiment, when the first PUSCH is not the initial PUSCH in the first PUSCH group, the first HARQ process identifier is (the HARQ process identifier associated with the initial PUSCH in the first PUSCH group+m-1) modulo nrofHARQ-Processes, wherein, m is the time domain position of the first PUSCH in the first PUSCH group, and m is a positive integer between 2 and Q, including 2 and Q, and wherein, the modulo is a modulo operation.

As one embodiment, when the first PUSCH is not the initial PUSCH in the first PUSCH group, the first HARQ process identifier is (the HARQ process identifier associated with the initial PUSCH in the first PUSCH group+M*(m−1)) modulo nrofHARQ-Processes, wherein, m is the time domain position of the first PUSCH in the first PUSCH group, and m is a positive integer between 2 and Q, including 2 and Q, and wherein, M is the number of PUSCH transmission occasions comprised in the first period, and the modulo is a modulo operation.

As one embodiment, the first HARQ process identifier is related to at least the former of the time domain resource where the initial PUSCH transmission occasion comprised in the first period is located and an index of a PUSCH transmission occasion where the first PUSCH is located in M PUSCH transmission occasions comprised in the first period.

As one embodiment, when the first PUSCH is sent in the initial PUSCH transmission occasion of the M PUSCH transmission occasions comprised in the first period, the first HARQ process identifier is only related to the time domain resources occupied by the first PUSCH.

As one embodiment, when the first PUSCH is sent in the initial PUSCH transmission occasion of the M PUSCH transmission occasions comprised in the first period, the first HARQ process identifier is associated with the first symbol occupied by the first PUSCH.

As one embodiment, when the first PUSCH is sent in the initial PUSCH transmission occasion of the M PUSCH transmission occasions comprised in the first period, the first HARQ process identifier is [floor(CURRENT_symbol/periodicity)] modulo nrofHARQ-Processes, wherein, the first message does not comprise a harq-ProcID-Offset2, and the first message does not comprise a cg-Retransmission Timer, and wherein, the floor (·) is a rounding down operation; and the modulo is a modulo operation.

As one embodiment, when the first PUSCH is sent in the initial PUSCH transmission occasion of the M PUSCH transmission occasions comprised in the first period, the first HARQ process identifier is [floor(CURRENT_symbol/periodicity)] modulo nrofHARQ-Processes+harq-ProcID-Offset2, wherein, the first message comprises the harq-ProcID-Offset2, and wherein, the floor (·) is a rounding down operation; the modulo is a modulo operation.

As one sub-embodiment of the above two embodiments, the CURRENT_symbol=(SFN×numberOfSlotsPerFrame×numberOfSymbolsPerSlot+slot number in the frame×numberOfSymbolsPerSlot+symbol number in the slot), wherein, the SFN (System Frame Number) is a system frame number where the initial PUSCH transmission occasion of the M PUSCH transmission occasions comprised in the first period is located, the numberOfSlotsPerFrame is the number of slots comprised in one frame, the numberOfSymbolsPerSlot is the number of symbols comprised in one slot, the slot number in the frame is a slot number of the initial PUSCH transmission occasion of the M PUSCH transmission occasions comprised in the first period in the system frame, and the symbol number in the slot is a first symbol of the initial PUSCH transmission occasion of the M PUSCH transmission occasions comprised in the first period in the slot.

As one embodiment, when the first PUSCH is sent in the non initial PUSCH transmission occasion of the M PUSCH transmission occasions comprised in the first period, the first HARQ process identifier is related to the time domain resource where the initial PUSCH transmission occasion is located and an index of a PUSCH transmission occasion where the first PUSCH is located in the M PUSCH transmission occasions comprised in the first period.

As one embodiment, when the first PUSCH is sent in the non initial PUSCH transmission occasion of the M PUSCH transmission occasions comprised in the first period, the first HARQ process identifier is (the HARQ process identifier associated with the PUSCH sent in the initial PUSCH transmission occasion of the M PUSCH transmission occasions comprised in the first period+m-1) modulo nrofHARQ-Processes, wherein, m is an index of a PUSCH transmission occasion where the first PUSCH is located in the M PUSCH transmission occasions comprised in the first period, and m is a positive integer between 2 and M, including 2 and M, and wherein, modulo is a modulo operation.

As one embodiment, when the first PUSCH is sent in the non initial PUSCH transmission occasion of the M PUSCH transmission occasions comprised in the first period, the first HARQ process identifier is (the HARQ process identifier associated with the PUSCH sent in the initial PUSCH transmission occasion of the M PUSCH transmission occasions comprised in the first period+M*(m−1)) modulo nrofHARQ-Processes, wherein, m is an index of a PUSCH transmission occasion where the first PUSCH is located in the M PUSCH transmission occasions comprised in the first period, and m is a positive integer between 2 and M, including 2 and M, and wherein, M is the number of PUSCH transmission occasions comprised in the first period, and the modulo is a modulo operation.

As one embodiment, the M PUSCH transmission occasions comprised in the first period belong to the periodic time-frequency resource set.

As one embodiment, a first bit block and first UCI are used together for generating a first PUSCH, the first UCI indicating a first HARQ process identifier, and the first bit block being associated with the first HARQ process identifier, wherein, the first PUSCH is one of all PUSCHs in the first PUSCH group.

As one embodiment, a first bit block and first UCI are used together for generating a first PUSCH, the first UCI indicating a first HARQ process identifier, and the first bit block being associated with the first HARQ process identifier, wherein, the first PUSCH is the initial PUSCH in the first PUSCH group.

As one embodiment, when the first PUSCH is not the initial PUSCH in the first PUSCH group, the first HARQ process identifier is related to a HARQ process identifier associated with the initial PUSCH in the first PUSCH group and a time domain position of the first PUSCH in the first PUSCH group, wherein, the HARQ process identifier associated with the initial PUSCH in the first PUSCH group is indicated by the first UCI carried by the initial PUSCH.

As one embodiment, the first HARQ process identifier is one of M candidate HARQ process identifiers.

As one embodiment, a time unit where PUSCH transmission occasions comprised in the first period are located is used for determining the M candidate HARQ process identifiers.

As one embodiment, the time unit where the PUSCH transmission occasions comprised in the first period are located and the number of the PUSCH transmission occasions comprised in the first period are used together for determining the M candidate HARQ process identifiers.

### Embodiment 6

Embodiment 6 illustrates a schematic diagram of a periodic time-frequency resource set according to one embodiment of the present application, as shown in FIG. 6. In FIG. 6, the thick line box represents one periodic time-frequency resource set, and each forward slash box in the thick line box represents one time-frequency resource in one periodic time-frequency resource set; and the duration of one period is a first period value, and one period comprises one periodic time-frequency resource set.

It should be noted that in FIG. 6, the slot is used as a time unit, and the time unit is not excluded as a subframe or symbol.

As one embodiment, the one periodic time-frequency resource set comprises at least one time-frequency resource.

As one embodiment, the one periodic time-frequency resource set comprises at least one time-frequency resource that is continuous in a time domain.

As one embodiment, the one periodic time-frequency resource set comprises at least one time-frequency resource that is discontinuous in the time domain.

As one embodiment, each time-frequency resource in the one periodic time-frequency resource set occupies the same time domain length.

As one embodiment, each time-frequency resource in the one periodic time-frequency resource set occupies different time domain lengths.

As one embodiment, each time-frequency resource in the one periodic time-frequency resource set occupies the same frequency domain resources.

As one embodiment, each time-frequency resource in the one periodic time-frequency resource set occupies different frequency domain resources.

As one embodiment, one time-frequency resource comprises at least one time domain resource and at least one frequency domain resource.

As one embodiment, one time domain resource comprises at least one symbol.

As one embodiment, one time domain resource comprises at least one slot.

As one embodiment, one frequency domain resource comprises at least one subcarrier.

As one embodiment, one frequency domain resource comprises at least one resource block (RB).

As one embodiment, the one periodic time-frequency resource set corresponds to one configured uplink grant.

As one embodiment, each time-frequency resource in the one periodic time-frequency resource set corresponds to one uplink grant.

As one embodiment, each time-frequency resource in the one periodic time-frequency resource set corresponds to one configured uplink grant.

As one embodiment, each time-frequency resource in the one periodic time-frequency resource set corresponds to one PUSCH transmission occasion.

As one embodiment, each time-frequency resource in the one periodic time-frequency resource set is used for sending one PUSCH.

As one embodiment, each time-frequency resource in the one periodic time-frequency resource set is used for sending one different bit block.

As one embodiment, the one periodic time-frequency resource set is used for sending at least two different bit blocks, wherein, the one periodic time-frequency resource set comprises at least two time-frequency resources.

As one embodiment, the first bit block belongs to the same logic channel.

As one embodiment, the bit block belongs to a logical channel configured to allow the use of the periodic time-frequency resource set.

In FIG. 6, the one periodic time-frequency resource set comprises three time-frequency resources, the three time-frequency resources being continuous in the time domain and having the same duration, and the three time-frequency resources having the same start position and bandwidth in the frequency domain; and each time-frequency resource set in the periodic time-frequency resource set is located at the start position of one period.

As one embodiment, each time-frequency resource set in the periodic time-frequency resource set is located at any time in one period in the time domain.

As one embodiment, the first period is any period in a plurality of periods.

### Embodiment 7

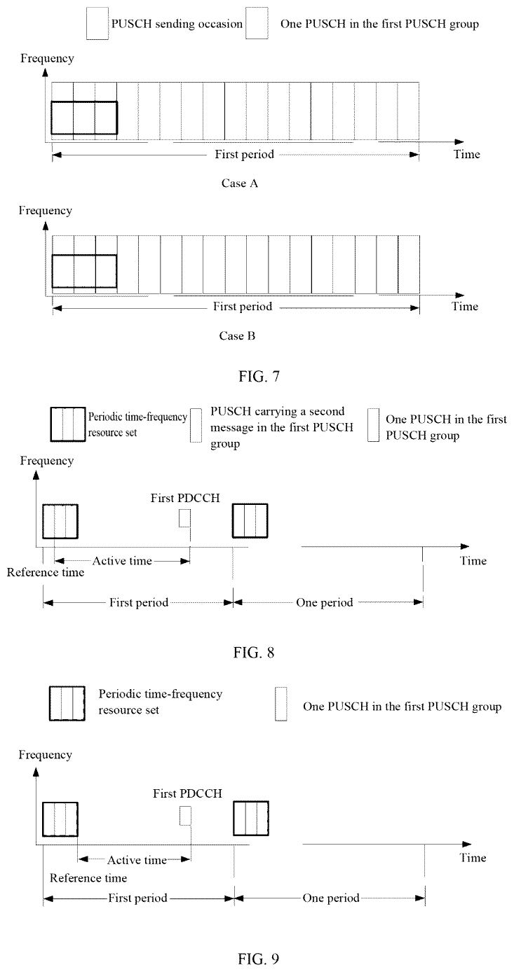

Embodiment 7 illustrates a schematic diagram of a first PUSCH group and a PUSCH transmission occasion during a first period according to one embodiment of the present application, as shown in FIG. 7. In FIG. 7, the forward slash box represents the PUSCH transmission occasion during the first period, and the grid box represents one PUSCH in the first PUSCH group.

As one embodiment, the first period comprises M PUSCH transmission occasions.

As one embodiment, the first PUSCH group comprises Q PUSCHs, and the first period comprises M PUSCH transmission occasions, wherein, the value of Q is not greater than the value of M.

As one embodiment, time domain resources of the first PUSCH group belong to the M PUSCH transmission occasions comprised in the first period.

As one embodiment, the sending of the first PUSCH group occupies Q continuous PUSCH transmission occasions.

As one embodiment, the sending of the first PUSCH group occupies the last Q PUSCH transmission occasions in the M PUSCH transmission occasions comprised in the first period.

As one embodiment, each time-frequency resource in one periodic time-frequency resource set corresponds to one PUSCH transmission occasion.

As one embodiment, one PUSCH transmission occasion is reserved for one PUSCH sending.

As one embodiment, whether to send a PUSCH at one PUSCH transmission occasion is determined by whether there is a data unit to be transmitted, wherein, the data unit belongs to a logical channel configured to allow the use of the periodic time-frequency resource set.

As one sub-embodiment of the above embodiment, when there is a data unit to be transmitted, a PUSCH is sent at one PUSCH transmission occasion; when there is no data unit to be transmitted, the PUSCH is not sent at one PUSCH transmission occasion.

As one embodiment, the first message indicates the number of PUSCH transmission occasions comprised in each period.

As one embodiment, the first message implicitly indicates the value of M by indicating the periodic time-frequency resource set.

As one embodiment, any time-frequency resource in any time-frequency resource set in the periodic time-frequency resource set corresponds to one PUSCH transmission occasion.

In case A of Embodiment 7, the first period comprises 3 PUSCH transmission occasions, the first PUSCH group comprises 3 PUSCHs, and the first PUSCH group is sent in the 3 PUSCH transmission occasions.

In case B of Embodiment 7, the first period comprises 3 PUSCH transmission occasions, the first PUSCH group comprises 2 PUSCHs, and the first PUSCH group is sent in the last 2 PUSCH transmission occasions of the 3 PUSCH transmission occasions.

### Embodiment 8

Embodiment 8 illustrates a schematic diagram of a relationship among a reference time, an active time, and a first PDCCH according to one embodiment of the present application, as shown in FIG. 8. In FIG. 8, the grid box represents a PUSCH carrying a second message in a first PUSCH group, the backslash box represents one PUSCH in the first PUSCH group, and each forward slash box in the bold box represents one time-frequency resource in one periodic time-frequency resource set.

As one embodiment, the active time comprises a time after a reference time and before a first PDCCH has been received, wherein, the first PDCCH is used for scheduling a new transmission.

As one embodiment, the phrase “a time after a reference time and before a first PDCCH has been received” comprises: a time after a reference time and until a first PDCCH is received.

As one embodiment, a target signaling is monitored during the active time.

As one embodiment, the reference time is a sending time of the PUSCH carrying the second message in the first PUSCH group.

As one embodiment, the reference time is the sending time of the initial PUSCH carrying the second message in the first PUSCH group.

As one embodiment, the reference time is the sending time of any PUSCH carrying the second message in the first PUSCH group.

As one embodiment, the sending time of the PUSCH is an end time of the PUSCH.

As one embodiment, the sending time of the PUSCH is the end time of the last symbol occupied by the PUSCH.

As one embodiment, the sending time of the PUSCH is the end time of the last slot occupied by the PUSCH.

As one embodiment, the second message is comprised in one MAC sub-PDU in one MAC PDU, the one MAC PDU being used for generating one PUSCH.

As one embodiment, the duration of the active time is less than the first period value.

As one embodiment, the sending time of the first PDCCH is earlier than a start time of time domain resources occupied by a periodic time-frequency resource set comprised in one period immediately following the first period.

### Embodiment 9

Embodiment 9 illustrates a schematic diagram of a relationship among another reference time, another active time and a first PDCCH according to one embodiment of the present application, as shown in FIG. 9. In FIG. 9, each backslash box in the bold box represents one PUSCH in a first PUSCH group, and each forward slash box in the bold box represents one time-frequency resource in one periodic time-frequency resource set.

Different from Embodiment 8, a reference time in Examination 9 is a sending time of the last PUSCH in the first PUSCH group.

### Embodiment 10

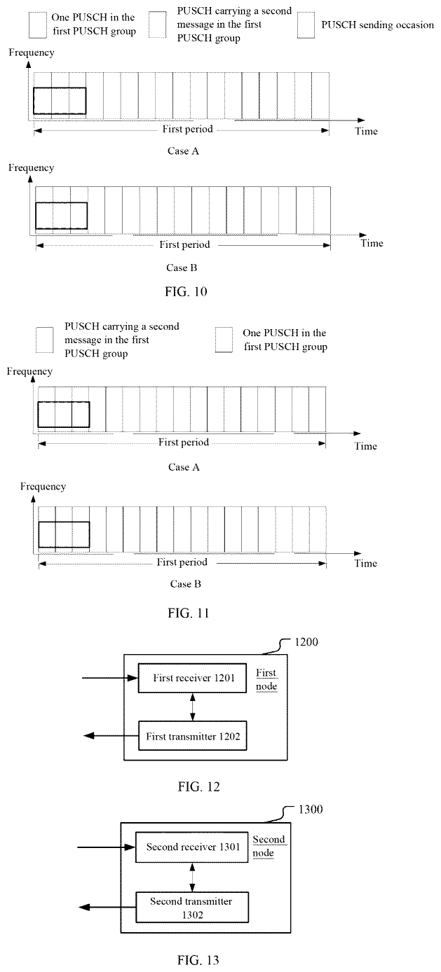

Embodiment 10 illustrates a schematic diagram of a relationship among a PUSCH carrying a second message in a first PUSCH group, a PUSCH transmission occasion, and a first PUSCH group according to one embodiment of the present application, as shown in FIG. 10. In FIG. 10, the grid box represents the PUSCH carrying the second message in the first PUSCH group, the forward slash box represents the PUSCH transmission occasion in a first period, and the reverse slash box represents one PUSCH in the first PUSCH group.

As one embodiment, the second message is carried on the initial PUSCH in the first PUSCH group for sending.

As one embodiment, the above method may give an early indication to the base station, so that the base station may perform dynamic scheduling early.

As one embodiment, the initial PUSCH in the first PUSCH group is sent at any PUSCH transmission occasion comprised in the first period.

As one embodiment, the initial PUSCH in the first PUSCH group is sent at the first PUSCH transmission occasion comprised in the first period.

As one embodiment, the initial PUSCH in the first PUSCH group is sent at the last PUSCH transmission occasion comprised in the first period.

As one embodiment, when the PUSCH carrying the second message is sent at the m^{th} PUSCH transmission occasion comprised in the first period, the PUSCH transmission occasion before the m^{th} PUSCH transmission occasion comprised in the first period is not used for sending a PUSCH, m being a positive integer greater than 1 and not greater than M.

In case A of Embodiment 10, the first period comprises 3 PUSCH transmission occasions, and the PUSCH carrying the second message is sent at the first PUSCH transmission occasion comprised in the first period.

In case B of Embodiment 10, the first period comprises 3 PUSCH transmission occasions, the PUSCH carrying the second message is sent at a third PUSCH transmission occasion comprised in the first period, and the first and second PUSCH transmission occasions comprised in the first period are not used for PUSCH sending.

### Embodiment 11

Embodiment 11 illustrates a schematic diagram of a relationship between a PUSCH carrying a second message in another first PUSCH group and a first PUSCH group according to one embodiment of the present application, as shown in FIG. 11. In FIG. 11, the grid box represents the PUSCH carrying the second message in the first PUSCH group, and the backslash box represents one PUSCH in the first PUSCH group.

As one embodiment, the second message is carried on any PUSCH in the first PUSCH group for sending.

As one embodiment, the second message is carried on the last PUSCH in the first PUSCH group for sending.

As one embodiment, the above method can report the amount of data arriving during the sending of the first PUSCH group, so that the base station may obtain a more accurate cache state.

In case A of Embodiment 11, the first period comprises 3 PUSCH transmission occasions, the first PUSCH group comprises 3 PUSCHs, the first PUSCH group is sent at the 3 PUSCH transmission occasions, and the PUSCH carrying the second message is the second of all PUSCHs in the first PUSCH group.

In case A of Embodiment 11, the first period comprises 3 PUSCH transmission occasions, the first PUSCH group comprises 3 PUSCHs, the first PUSCH group is sent at the 3 PUSCH transmission occasions, and the PUSCH carrying the second message is the third of all PUSCHs in the first PUSCH group.

### Embodiment 12

Embodiment 12 illustrates a structural block diagram of a processing apparatus in a first node according to one embodiment of the present application, as shown in FIG. 12. In FIG. 12, a processing apparatus 1200 in the first node comprises a first receiver 1201 and a first transmitter 1202. The first node 1200 is a piece of UE.

In Embodiment 12, the first receiver 1201 receives a first message, the first message indicating a first period value and a periodic time-frequency resource set; the first transmitter 1202 sends a first PUSCH group during a first period, a time-frequency resource set occupied by the first PUSCH group belonging to the periodic time-frequency resource set, the first PUSCH group comprising a second message, and the second message indicating a cache state; the first receiver 1201 monitors a target signaling after a reference time and before a first PDCCH has been received, the first PDCCH being used for scheduling a new transmission, wherein, the first PUSCH group comprises Q PUSCHs, Q being a positive integer greater than 0; the duration of the first period is the first period value; and the reference time is related to the first PUSCH group.

As one embodiment, the reference time is a sending time of a PUSCH carrying the second message in the first PUSCH group.

As one embodiment, the reference time is the sending time of the last PUSCH in the first PUSCH group.

As one embodiment, the second message is carried on any PUSCH in the first PUSCH group for sending.

As one embodiment, the second message is carried on the initial PUSCH in the first PUSCH group for sending.

As one embodiment, the first transmitter 1202 sends a second PUSCH, the first PDCCH being used for scheduling the second PUSCH, wherein, the second PUSCH comprises a data unit of at least a first logical channel, the at least first logical channel being allowed to be sent through the periodic time-frequency resource set.

As one embodiment, the value of Q is not greater than the value of M, M being the number of PUSCH transmission occasions comprised in the first period.

As one embodiment, a first bit block is used for generating a first PUSCH, the first bit block being associated with a first HARQ process identifier, wherein, the first PUSCH is one of all PUSCHs in the first PUSCH group, and the first HARQ process identifier is related to at least the former of a time domain resource occupied by the initial PUSCH in the first PUSCH group and a time domain position of the first PUSCH in the first PUSCH group.

As one embodiment, the first receiver 1201 comprises a receiving device 454 (comprising an antenna 452), a receiving processor 456, a multi-antenna receiving processor 458, and a controller/processor 459 in FIG. 4 of the present application.

As one embodiment, the first receiver 1201 comprises at least one of the receiving device 454 (comprising the antenna 452), the receiving processor 456, the multi-antenna receiving processor 458, or the controller/processor 459 in FIG. 4 of the present application.

As one embodiment, the first transmitter 1202 comprises a transmitting device 454 (comprising the antenna 452), a transmitting processor 468, a multi-antenna transmitting processor 457, and the controller/processor 459 in FIG. 4 of the present application.

As one embodiment, the first processing device 1202 comprises at least one of the transmitting device 454 (comprising the antenna 452), the transmitting processor 468, the multi-antenna transmitting processor 457, or the controller/processor 459 in FIG. 4 of the present application.

### Embodiment 13

Embodiment 13 illustrates a structural block diagram of a processing apparatus in a second node according to one embodiment of the present application, as shown in FIG. 13. In FIG. 13, a processing apparatus 1300 in the second node comprises a second receiver 1301 and a second transmitter 1302. The second node 1300 is one base station.

In Embodiment 13, the second transmitter 1302 sends a first message, the first message indicating a first period value and a periodic time-frequency resource set; the second receiver 1301 receives a first PUSCH group during a first period, a time-frequency resource set occupied by the first PUSCH group belonging to the periodic time-frequency resource set, the first PUSCH group comprising a second message, and the second message indicating a cache state, wherein, a target signaling is monitored after a reference time and before a first PDCCH has been received; the first PDCCH is used for scheduling a new transmission; the first PUSCH group comprises Q PUSCHs, Q being a positive integer greater than 0; the duration of the first period is the first period value; and the reference time is related to the first PUSCH group.

As one embodiment, the reference time is a sending time of the PUSCH carrying the second message in the first PUSCH group.

As one embodiment, the reference time is the sending time of the last PUSCH in the first PUSCH group.

As one embodiment, the second message is carried on any PUSCH in the first PUSCH group for sending.

As one embodiment, the second message is carried on the initial PUSCH in the first PUSCH group for sending.

As one embodiment, the second transmitter 1302 sends the first PDCCH; and the second receiver 1301 receives a second PUSCH, the first PDCCH being used for scheduling the second PUSCH, wherein, the second PUSCH comprises a data unit of at least a first logical channel, the at least first logical channel being allowed to be sent through the periodic time-frequency resource set.

As one embodiment, the value of Q is not greater than the value of M, M being the number of PUSCH transmission occasions comprised in the first period.

As one embodiment, a first bit block is used for generating a first PUSCH, the first bit block being associated with a first HARQ process identifier, wherein, the first PUSCH is one of all PUSCHs in the first PUSCH group, and the first HARQ process identifier is related to at least the former of a time domain resource occupied by the initial PUSCH in the first PUSCH group and a time domain position of the first PUSCH in the first PUSCH group.

As one embodiment, the second receiver 1301 comprises a receiving device 418 (comprising an antenna 420), a receiving processor 470, a multi-antenna receiving processor 472, and a controller/processor 475 in FIG. 4 of the present application.

As one embodiment, the second receiver 1301 comprises at least one of the receiving device 418 (comprising the antenna 420), the receiving processor 470, the multi-antenna receiving processor 472, or the controller/processor 475 in FIG. 4 of the present application.

As one embodiment, the second transmitter 1302 comprises a transmitting device 418 (comprising the antenna 420), a transmitting processor 416, a multi-antenna transmitting processor 471, and the controller/processor 475 in FIG. 4 of the present application.

As one embodiment, the second transmitter 1302 comprises at least one of the transmitting device 418 (comprising the antenna 420), the transmitting processor 416, the multi-antenna transmitting processor 471, and the controller/processor 475 in FIG. 4 of the present application.

Those of ordinary skill in the art can understand that all or part of the steps in the above method may be completed by instructing relevant hardware through a program, and the program may be stored in a computer-readable storage medium, such as a read-only memory, a hard disk or an optical disk. Optionally, all or part of the steps in the above embodiments may also be implemented using one or more integrated circuits. Accordingly, each module unit in the above embodiments may be implemented in the form of hardware or in the form of a software function module, and the present application is not limited to any specific form of software and hardware combination. The first type of communication node or UE or terminal in the present application includes, but is not limited to, mobile phones, tablet computers, laptops, network cards, low-power devices, eMTC (enhanced Machine Type Communication) devices, NB-IoT devices, vehicle-mounted communication devices, aircrafts, airplanes, drones, remote-controlled airplanes and other wireless communication devices. The second type of communication node or base station or network-side device in the present application includes, but is not limited to, macro base stations, micro base stations, Femtocells, relay base stations, eNBs, gNBs, transmitter receiver points (TRPs), relay satellites, satellite base stations, aerial base stations and other wireless communication devices.

The above is only a preferred embodiment of the present application and is not used to limit the scope of protection of the present application. Any modifications, equivalent replacements, improvements, etc. made within the spirit and principles of the present application should be comprised in the scope of protection of the present application.

1. A user equipment (UE) used for wireless communication, the UE comprising:
a transceiver; and
a processor, wherein the transceiver and the processor are configured to:
receive a first message indicating a first period value and a periodic time-frequency resource set;
send a first physical uplink shared channel (PUSCH) group during a first period, a time-frequency resource set occupied by the first PUSCH group belonging to the periodic time-frequency resource set, the first PUSCH group comprising a second message, and the second message indicating a cache state; and
monitor a target signaling after a reference time and before a first physical downlink control channel (PDCCH) has been received, the first PDCCH being used for scheduling a new transmission;
wherein the first PUSCH group comprises one or more PUSCHs, the duration of the first period is the first period value; and the reference time is related to the first PUSCH group.

2. The UE according to claim 1, wherein the reference time is a sending time of the PUSCH carrying the second message in the first PUSCH group.

3. The UE according to claim 1, wherein the reference time is a sending time of the last PUSCH in the first PUSCH group.

4. The UE according to any one of claim 1, wherein the second message is carried on any PUSCH in the first PUSCH group for sending.

5. The UE according to claim 1, wherein the second message is carried on the initial PUSCH in the first PUSCH group for sending.

6. The UE according to claim 1, wherein the transceiver and the processor are further configured to:
receive the first PDCCH; and
send a second PUSCH, the first PDCCH being used for scheduling the second PUSCH,
wherein the second PUSCH comprises a data unit of at least a first logical channel, the at least first logical channel being allowed to be sent through the periodic time-frequency resource set.

7. The UE according to claim 1, wherein a number of the one or more PUSCHs is not greater than a number of PUSCH transmission occasions comprised in the first period.

8. The UE according to claim 1, wherein a first bit block is used for generating a first PUSCH, and the first bit block is associated with a first HARQ process identifier,
wherein the first PUSCH is one of all PUSCHs in the first PUSCH group, and the first HARQ process identifier is related to at least the former of a time domain resource occupied by the initial PUSCH in the first PUSCH group and a time domain position of the first PUSCH in the first PUSCH group.

9. A base station used for wireless communication, the base station comprising:
a transceiver; and
a processor, wherein the transceiver and the processor are configured to:
send a first message indicating a first period value and a periodic time-frequency resource set; and
receive a first physical uplink shared channel (PUSCH) group during a first period, a time-frequency resource set occupied by the first PUSCH group belonging to the periodic time-frequency resource set, the first PUSCH group comprising a second message, and the second message indicating a cache state;
wherein a target signaling is monitored after a reference time and before a first physical downlink control channel (PDCCH) has been received, the first PDCCH being used for scheduling a new transmission; the first PUSCH group comprises one or more PUSCHs, the duration of the first period is the first period value; and the reference time is related to the first PUSCH group.

10. The base station according to claim 9, wherein the reference time is a sending time of the PUSCH carrying the second message in the first PUSCH group.

11. The base station according to claim 9, wherein the reference time is a sending time of the last PUSCH in the first PUSCH group.

12. The base station according to claim 9, wherein the second message is carried on any PUSCH in the first PUSCH group for sending.

13. The base station according to claim 9, wherein the second message is carried on the initial PUSCH in the first PUSCH group for sending.

14. The base station according to claim 9, wherein the transceiver and the processor are further configured to:
send the first PDCCH; and
receive a second PUSCH, the first PDCCH being used for scheduling the second PUSCH,
wherein the second PUSCH comprises a data unit of at least a first logical channel, the at least first logical channel being allowed to be sent through the periodic time-frequency resource set.

15. The base station according to claim 9, wherein a number of the one or more PUSCHs is not greater than a number of PUSCH transmission occasions comprised in the first period.

16. The base station according to of claim 9, wherein a first bit block is used for generating a first PUSCH, and the first bit block is associated with a first HARQ process identifier,
wherein the first PUSCH is one of all PUSCHs in the first PUSCH group, and the first HARQ process identifier is related to at least the former of a time domain resource occupied by the initial PUSCH in the first PUSCH group and a time domain position of the first PUSCH in the first PUSCH group.

17. A method used in a user equipment (UE) for wireless communication, the method comprising:
receiving a first message, the first message indicating a first period value and a periodic time-frequency resource set;
sending a first physical uplink shared channel (PUSCH) group during a first period, a time-frequency resource set occupied by the first PUSCH group belonging to the periodic time-frequency resource set, the first PUSCH group comprising a second message, and the second message indicating a cache state; and
monitoring a target signaling after a reference time and before a first physical downlink control channel (PDCCH) has been received, the first PDCCH being used for scheduling a new transmission,
wherein the first PUSCH group comprises one or more PUSCHs, the duration of the first period is the first period value; and the reference time is related to the first PUSCH group.

18. The method according to claim 17, wherein the reference time is a sending time of the PUSCH carrying the second message in the first PUSCH group.

19. The method according to claim 17, wherein the reference time is a sending time of the last PUSCH in the first PUSCH group.

20. The method according to claim 17, wherein the second message is carried on any PUSCH in the first PUSCH group for sending.

21.-32. (canceled)
